(19) United States
(12) Patent Application Publication
(10) Pub. No.: US 2026/0312314 A1
(43) Pub. Date: Oct. 8, 2026

(54) CARD EDGE CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: MING-CHING CHEN, New Taipei (TW)

(21) Appl. No.: 19/640,903

(22) Filed: Apr. 7, 2026

(30) Foreign Application Priority Data
Apr. 8, 2025 (CN) 202520647781.7

(51) Int. Cl. H01R 12/73; H01R 12/70; H01R 12/72

(52) U.S. Cl. CPC H01R 12/737; H01R 12/7005; H01R 12/721

(57) ABSTRACT

A card edge connector includes: an insulating housing having two opposite side walls and a mating slot; plural terminals arranged on the side walls, each terminal having a contact portion exposed in the mating slot, a head portion extending upward from the contact portion, a connecting portion, and a soldering portion; and a terminal protection member covering the head portions for guiding insertion of the electronic card; wherein each terminal has an inner face facing the mating slot and an outer face opposite to the inner face, as viewed in the first direction, the contact portion has an arc segment extending outward from the inner face of the connecting portion, the head portion has a retaining section extending obliquely outward from the arc segment, and a recessed portion is formed at a junction between the arc segment and the retaining section.

### BACKGROUND OF THE INVENTION

### 1. Field of the Invention

The present invention relates generally to a card edge connector, and particularly to a card edge connector for transmitting high-frequency signals.

### 2. Description of Related Arts

U.S. Pat. No. 8,636,548 discloses an card edge connector for a daughter board, including an insulating housing extending along a longitudinal direction and a plurality of terminals retained in the insulating housing. The housing has opposite first side wall and second side wall and a central slot formed between the first and second side walls for receiving the daughter board. The central slot defines a first centerline along the longitudinal direction. Each conductive terminal has a retaining portion fixed within the insulating housing and a contact portion extending upward from the retaining portion into the central slot for contact with the daughter board. The upper ends of the first and second side walls are both formed with a retaining wall. The retaining wall is used to prevent an extended end of the terminal from extending into the central slot and contacting the daughter board, thereby protecting the terminals from being damaged. However, the terminal has a long head portion above the contact portion, which is likely to cause a stub effect and adversely affects transmission performance of high-frequency signals of the card edge connector.

An improved card edge connector is desired.

### SUMMARY OF THE INVENTION

An object of the present invention is to provide a card edge connector for improving the transmission performance of high-frequency signals.

To achieve the above-mentioned object, a card edge connector for mating with an electronic card comprises: an insulating housing having two opposite side walls extending in a first direction and a mating slot located between the two side walls; a plurality of terminals arranged on the side walls, each terminal having a contact portion exposed in the mating slot, a head portion extending upward from the contact portion, a connecting portion extending downward from the contact portion, and a soldering portion extending from the connecting portion out of the insulating housing; and a terminal protection member covering the head portions of the terminals for guiding insertion of the electronic card; wherein each terminal comprises an inner face facing the mating slot and an outer face facing the side wall and opposite to the inner face, as viewed in the first direction, the contact portion has an arc segment extending outward from the inner face of the connecting portion, the head portion has a retaining section extending obliquely outward from the arc segment, and a recessed portion is formed at a junction between the arc segment and the retaining section.

Other advantages and novel features of the invention will become more apparent from the following detailed description of the present embodiment when taken in conjunction with the accompanying drawings.

### BRIEF DESCRIPTION OF DRAWINGS

FIG. 1 is a perspective view of a card edge connector of an embodiment of the present invention;

FIG. 2 is a perspective view of a portion of a card edge connector of an embodiment of the present invention;

FIG. 3 is a perspective view of FIG. 2 from another angle;

FIG. 4 is an exploded perspective view of FIG. 2;

FIG. 5 is a perspective view of FIG. 4 from another angle;

FIG. 6 is a further exploded perspective view of a terminal module in FIG. 4;

FIG. 7 is a sectional view taken along line A-A of FIG. 2; and

FIG. 8 is a sectional view showing an electronic card inserted in FIG. 7.

### DETAILED DESCRIPTION OF THE PREFERRED EMBODIMENT

Reference will now be made to the drawing figures to describe the preferred embodiment of the present invention in detail.

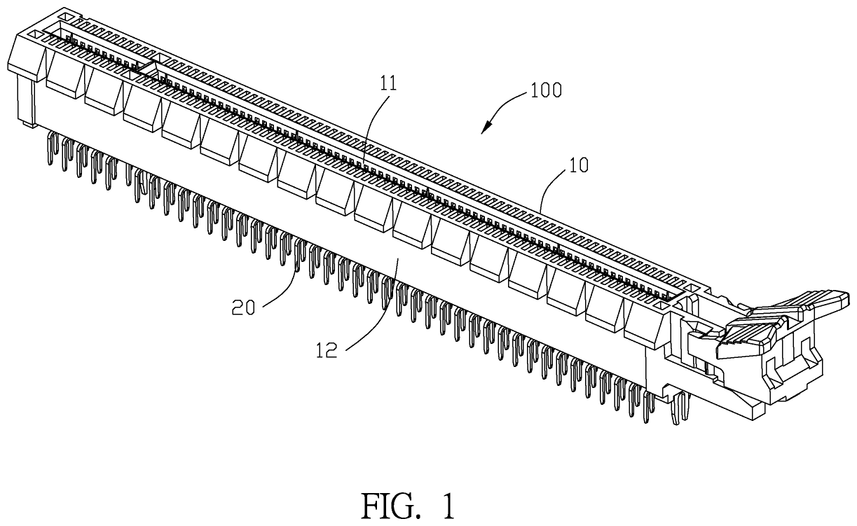

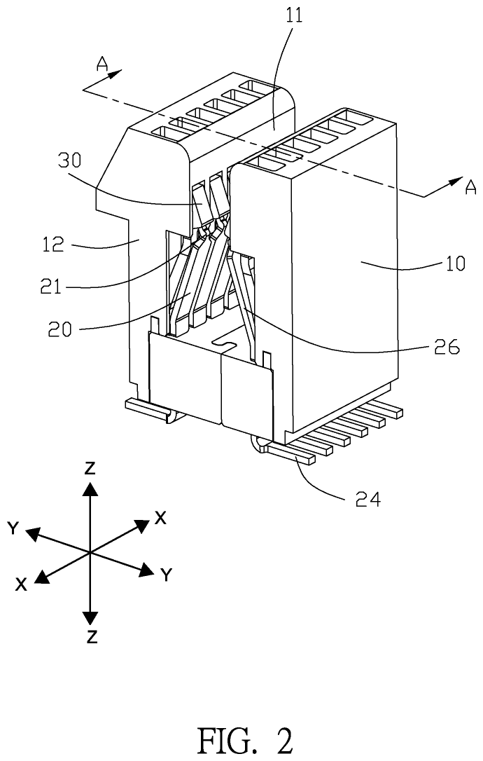

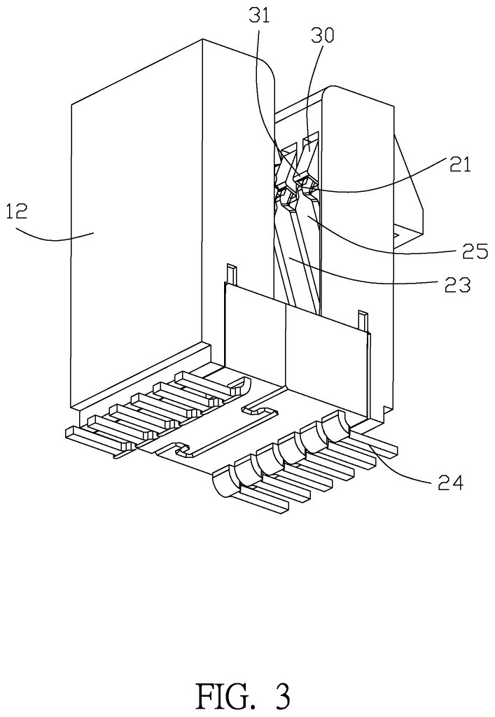

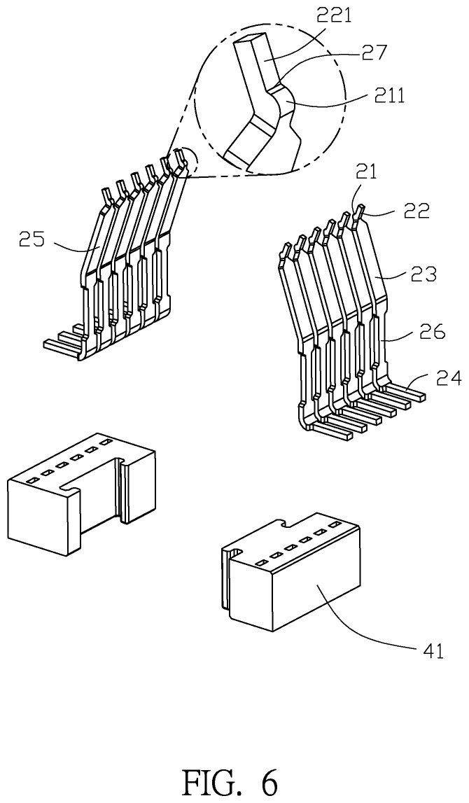

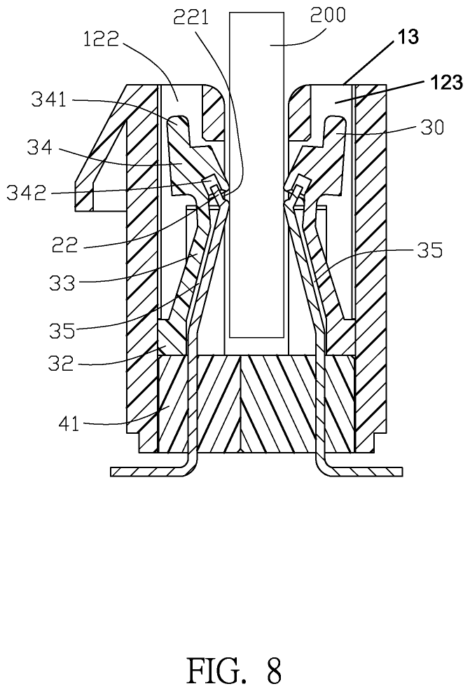

FIG. 1 is a perspective view of a card edge connector 100 of an embodiment the present invention. The card edge connector 100 is mounted on a circuit board (not shown) to receive an electronic card 200 (shown in FIG. 8) in a mating direction Z-Z. The card edge connector 100 includes an insulating housing 10 and a plurality of terminals 20. The insulating housing 10 has two opposite side walls 12 extending in a first direction X-X, a mating slot 11 located between the two side walls 12. The plurality of terminals 20 arranged on the side walls 12. The card edge connector 100 of the present invention can be mounted to the circuit board by either surface mount technology or through-hole technology, with different mounting methods corresponding to different terminal soldering portions. The perspective view of the card edge connector in FIG. 1 shows an example using through-hole mounting technology, while FIGS. 2 to 8 show partial views of the card edge connector using surface mount technology. FIG. 1 is only used to illustrate the basic appearance of the card edge connector for ease of understanding, and does not have a substantial impact on the technical solution of this invention.

Referring to FIGS. 2 to 7, the terminals 20 are arranged on the side walls 12 and each includes a contact portion 21 exposed in the mating slot 11, a head portion 22 extending upward from the contact portion 21, a connecting portion 23 extending downward from the contact portion 21, and a soldering portion 24 extending from the connecting portion 23 out of the insulating housing 10. The contact portion 21 is capable of electrically contacting the electronic card 200 inserted into the mating slot 11, and the soldering portion is mounted to the circuit board.

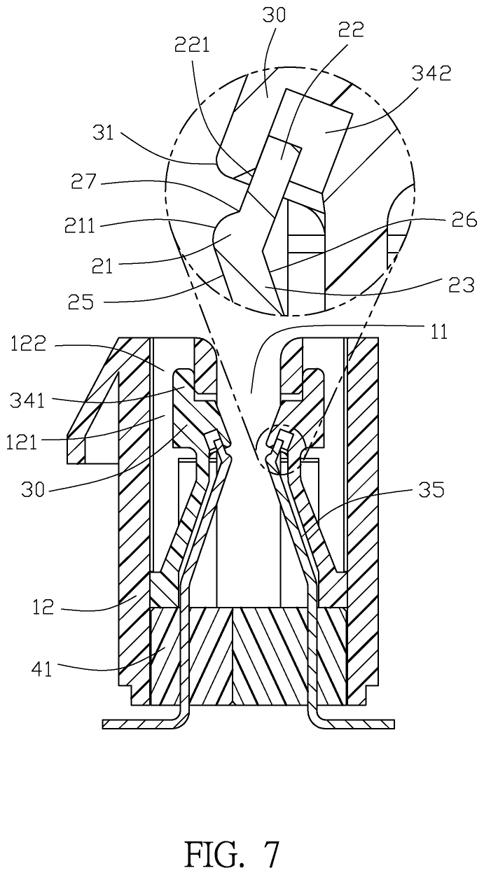

Referring to FIGS. 2, 3, and 7, the card edge connector 100 includes a terminal protection member 30 covering the head portion 22 of the terminals 20 and guiding the insertion of the electronic card. FIG. 7 shows the state when the electronic card is not inserted into the slot 11. Referring to FIG. 8, at the initial stage of inserting the electronic card into the mating slot 11, the terminal protection member 30 guides the electronic card for insertion. As the electronic card continues to be inserted, the contact portion 21 of the terminal is pressed by the electronic card and moves within the terminal protection member 30 in a second direction Y-Y perpendicular to the first direction X-X. The terminal protection member 30 has an abutting portion 31 protruding toward the mating slot 11. The abutting portion 31 covers the head portion 22 of the terminal 20 and abuts against the electronic card. A receiving slot 121 is recessed in the side wall 12 adjacent to the mating slot 11. The terminal protection member 30 is disposed in the receiving slot 121. In the second direction, a floating gap 122 is located between the receiving slot 121 and the terminal protection member 30. The terminal protection member 30 protects the head portion 22 and can prevent the head portion 22 from being exposed and damaged by impact from the electronic card.

Referring to FIGS. 2, 6, and 7, each terminal 20 includes an inner face 25 facing the mating slot 11 and an outer face 26 facing the side wall 12 and opposite to the inner face 25. As viewed in the first direction, the contact portion 21 includes an arc segment 211 extending outward from the inner face 25 of the connecting portion 23, and the head portion 22 includes a retaining section 221 extending obliquely outward from the arc segment 211. A recessed portion 27 is formed at the junction between the arc segment 211 and the retaining section 221, so that the contact portion 21 is formed as a protruding structure at the location of the arc segment 211. As shown in FIG. 7, before the electronic card 200 is inserted into the mating slot 11, the retaining section 221 abuts against the terminal protection member 30. Referring to FIG. 8 and the foregoing description, after the electronic card 200 is inserted into the mating slot 11, the arc segment 211 contacts the electronic card 200, and the retaining section 221 floats relative to the terminal protection member 30 in the second direction. Such a configuration is advantageous for shortening the length of the head portion 22 of the terminal, thereby improving the high-frequency transmission performance of the card edge connector 100. As described of the related arts, in order to prevent the terminals from being damaged by the insertion of the electronic card, the terminal has a long head portion above the contact portion, and the long head portion easily causes a stub effect and thus affects high-frequency transmission performance. If the head portion of the terminal is shortened, the terminal protection member must be adaptively arranged downward and inward to cover the head portion, which may result in poor contact stability between the electronic card and the contact portion of the terminal. Therefore, the recessed portion 27 is equivalent to thinning the traditional terminal head at the inner face, thereby providing space for the terminal protection member 30. This is beneficial for shortening the length of the head portion 22 of the terminal and ensuring stable contact between the electronic card 200 and the contact portion 21 of the terminal after insertion.

To optimize the protruding structure of the contact portion 21, in a preferred embodiment, a radius of the arc segment 211 is less than a thickness of the connecting portion 23. Referring to FIG. 7, the recessed portion 27 is located between an extension line of the inner face 25 of the connecting portion 23 and an extension line of the outer face 26 of the connecting portion 23 as viewed in the first direction. The inner face 25 of the head portion 22 joins the contact portion 21, and the outer face 26 of the head portion 22 joins the outer face 26 of the connecting portion 23. To provide space for the terminal protection member 30, in this embodiment, a thickness of the head portion 22 is less than a thickness of the connecting portion 23.

The terminal 20 of the present invention has a short head portion 22. When viewed in the first direction, a length of the inner face 25 of the head portion 22 is less than twice the thickness of the connecting portion 23, and a length of the outer face 26 of the head portion 22 is greater than twice but less than three times the thickness of the connecting portion 23. In a preferred embodiment, the thickness of the connecting portion 23 is 0.25 mm, the radius of the arc segment 211 is 0.15 mm, and the thickness of the head portion 22 is 0.2 mm. When viewed in the first direction, the length of the inner face 25 of the head portion 22 is 0.46 mm, and the length of the outer face 26 of the head portion 22 is 0.62 mm.

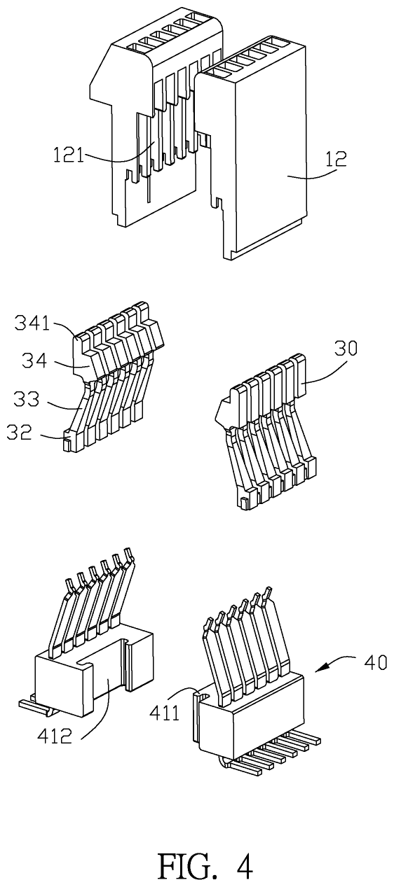

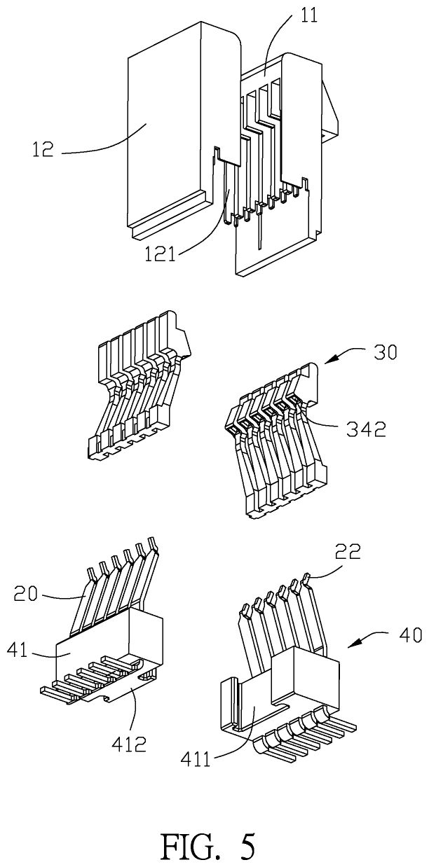

As shown in FIGS. 4 and 5, in this embodiment, the card edge connector 100 includes two terminal protection members 30 located on the two side walls respectively. Each terminal protection member 30 has a base portion 32, a plurality of extending portions 33 extending upward from the base portion 32, and a plurality of floating heads 34 extending upward from the corresponding extending portion 33. The extending portion 33 corresponds one-to-one with the terminals 20, and the floating head 34 covers the corresponding head portion 22 of the terminal 20. The floating head 34 covers the head portion 22 of the terminal 20. The extending portion 33 and the connecting portion 23 of the terminal are arranged in parallel. A gap 35 is located between the extending portion 33 and the connecting portion 23. The gap 35 is beneficial for reducing the impedance of the connecting portion 23. Referring to FIGS. 7 and 8, in this embodiment, when the retaining section 221 abuts against the terminal protection member 30, the gap is 0.15 mm.

Referring to FIGS. 7 to 8, the receiving slot 121 includes a positioning slot 123 adjacent to a mating face 13 of the insulating housing 10, the positioning slot 123 being located between an inner face and an outer face of the corresponding side wall 12. The floating head 34 has a protrusion 341 inserted into the positioning slot 123 of the receiving slot 121. The positioning slot 123 restricts the protrusion 341 in the second direction. Before the electronic card is inserted, the protrusion 341 abuts against the side wall 12 in the direction toward the mating slot 11. The floating head 34 has a protective groove 342 corresponding to the head portion 22. The protective groove 342 is open downward, and the head portion 22 is positioned within the corresponding protective groove 342. At the initial stage of inserting the electronic card into the mating slot 11, the abutting portion 31 can be pushed by the electronic card in the second direction, that is, the protrusion 341 moves within the floating gap 122 in the second direction. As the electronic card continues to be inserted, the head portion 22 can be pushed to move within the protective groove 342 in the second direction, and the retaining section 221 disengages from abutting against the terminal protection member 30. At this time, the gap 35 is 0.12 mm.

Referring to FIGS. 2 to 5, the card edge connector 100 includes at least two terminal modules 40. Each terminal module 40 includes an insulating block 41 and the terminals 20 retained in the insulating block 41. Each terminal module 40 retains a row of terminals 20. In this embodiment, the terminal protection member 30 is inserted upward into the corresponding receiving slot 121 located in the side wall 12. The two terminal modules 40 are assembled together firstly and then inserted between the terminal protection members 30 corresponding to the two side walls 12. Each of the head portions 22 is positioned within the corresponding protective groove 342. The two insulating blocks 41 have complementary dovetail slots 411 and dovetail protrusions 412 respectively, with the dovetail protrusion 412 being engaging in the corresponding dovetail slot 411 to assemble the two terminal modules 40 together.

The above-mentioned embodiments are only preferred embodiments of the present invention, and should not limit the scope of the present invention, any simple equivalent changes and modifications made according to the claims of the present invention and the contents of the description should still belong to the present invention.

1. A card edge connector for mating with an electronic card, comprising:
an insulating housing having two opposite side walls extending in a first direction and a mating slot located between the two side walls;
a plurality of terminals arranged on the side walls, each terminal having a contact portion exposed in the mating slot, a head portion extending upward from the contact portion, a connecting portion extending downward from the contact portion, and a soldering portion extending from the connecting portion out of the insulating housing; and
a terminal protection member covering the head portions of the terminals for guiding insertion of the electronic card;
wherein each terminal comprises an inner face facing the mating slot and an opposite outer face facing the side wall, the contact portion has an arc segment extending outward from the inner face of the connecting portion, the head portion has a retaining section extending obliquely outward from the arc segment, and a recessed portion is formed at a junction between the arc segment and the retaining section.

2. The card edge connector as claimed in claim 1, wherein a radius of the arc segment is less than a thickness of the connecting portion.

3. The card edge connector as claimed in claim 1, wherein before the electronic card is inserted into the mating slot, the retaining section abuts against the terminal protection member, and after the electronic card is inserted into the mating slot, the arc segment contacts the electronic card and the retaining section floats relative to the terminal protection member.

4. The card edge connector as claimed in claim 1, wherein the contact portion is formed as a protruding structure at the location of the arc segment.

5. The card edge connector as claimed in claim 4, wherein the recessed portion is located between an extension line of the inner face of the connecting portion and an extension line of the outer face of the connecting portion as viewed in the first direction.

6. The card edge connector as claimed in claim 1, wherein a thickness of the head portion is less than a thickness of the connecting portion.

7. The card edge connector as claimed in claim 1, wherein the inner face of the head portion joins the contact portion, and the outer face of the head portion joins the outer face of the connecting portion.

8. The card edge connector as claimed in claim 7, wherein a length of the inner face of the head portion is less than twice a thickness of the connecting portion as viewed in the first direction.

9. The card edge connector as claimed in claim 7, wherein when viewed in the first direction, a length of the outer face of the head portion is greater than twice a thickness of the connecting portion and less than three times the thickness of the connecting portion.

10. The card edge connector as claimed in claim 7, wherein a thickness of the connecting portion is about 0.25 mm, a radius of the arc segment is about 0.15 mm, and a thickness of the head portion is about 0.2 mm and when viewed in a direction perpendicular to the thickness of the terminal, a length of the inner face of the head portion is about 0.46 mm, and a length of the outer face of the head portion is about 0.62 mm.

11. The card edge connector as claimed in claim 1, wherein at an initial stage of inserting the electronic card into the mating slot, the terminal protection member guides the electronic card for insertion, and as the electronic card continues to be inserted, the contact portion of the terminal is pressed by the electronic card and moves within the terminal protection member in a second direction perpendicular to the first direction.

12. The card edge connector as claimed in claim 11, wherein the terminal protection member has an abutting portion protruding toward the mating slot, and the abutting portion covers the head portion of the terminal and abuts against the electronic card.

13. The card edge connector as claimed in claim 11, wherein a receiving slot is recessed in the side wall adjacent to the mating slot, the terminal protection member is disposed in the receiving slot, and a floating gap is located between the receiving slot and the terminal protection member in the second direction.

14. The card edge connector as claimed in claim 13, wherein the terminal protection member has a base portion, at least one extending portion extending upward from the base portion, and a floating head extending upward from the extending portion, and the floating head covers the head portion of the terminal.

15. The card edge connector as claimed in claim 14, wherein the extending portion corresponds to the terminal, and the extending portion and the connecting portion of the terminal are arranged in parallel.

16. The card edge connector as claimed in claim 14, wherein the receiving slot comprises a positioning slot adjacent to a mating surface of the insulating housing, the positioning slot being located between an inner face and an outer face of a corresponding side wall, the floating head has a protrusion inserted into the positioning slot, and the positioning slot restricts the protrusion in the second direction.

17. The card edge connector as claimed in claim 14, wherein the floating head has a protective groove opening downward, and the head portion is positioned within the protective groove.

18. A card edge connector for mating with an electronic card, comprising:
an insulating housing having a mating slot extending in a first direction and two side walls located on both sides of the mating slot;
a plurality of terminals arranged on the side walls, each terminal comprising a contact portion exposed in the mating slot, a head portion extending upward from the contact portion, a connecting portion extending downward from the contact portion, and a soldering portion extending from the connecting portion out of the insulating housing; and
a terminal protection member protecting the head portions and guiding the insertion of the electronic card;
wherein the contact portion has a protruding structure facing to the mating slot, the head portion extends obliquely outward from the protruding structure, and a recessed portion is formed at a junction between the protruding structure and the head portion.

19. The card edge connector as claimed in claim 18, wherein each terminal comprises an inner face facing the mating slot and an opposite outer face facing the side wall, the protruding structure has an arc segment extending outward from the inner face of the connecting portion, the head portion has a retaining section extending obliquely outward from the arc segment, the recessed portion is formed at the junction between the arc segment and the retaining section, and the recessed portion is located between an extension line of the inner face of the connecting portion and an extension line of the outer face of the connecting portion.

20. The card edge connector as claimed in claim 19, wherein as viewed in the first direction, a length of the inner face of the head portion is less than twice a thickness of the connecting portion, and a length of the outer face of the head portion is greater than twice the thickness of the connecting portion and less than three times the thickness of the connecting portion.
